(19) United States
(12) Patent Application Publication
(10) Pub. No.: US 2019/0176686 A1
(43) Pub. Date: Jun. 13, 2019

(54) MOTOR VEHICLE LIGHT COVER

(71) Applicant: AMERICAN CRAFT AND DESIGN LLC, Miami, FL (US)

(72) Inventor: Daniel Acero, Miami, FL (US)

(21) Appl. No.: 16/216,571

(22) Filed: Dec. 11, 2018

Related U.S. Application Data
(60) Provisional application No. 62/597,158, filed on Dec. 11, 2017.

(51) Int. Cl. B60Q 1/26; B60Q 1/30

(52) U.S. Cl. CPC B60Q 1/2623; B60Q 1/30

(57) ABSTRACT

A cover for a motor vehicle light is disclosed. The cover includes a base having a cylindrical shape with a closed top end and an open bottom end, wherein at least the top end of the base is comprised of a light permeable material, flanges extending perpendicularly from the bottom end of the base, wherein the flanges mate with slots located along a circumference of a motor vehicle light, a first surface on an exterior surface of the base, a cap, bars extending across the top of the cap, the bars comprised of a material that blocks light, a second surface on the cap configured to mate with the first surface of the base, wherein when the cap is welded onto the base, light from the motor vehicle light passes through the top end of the base and is blocked by the bars.

### CROSS-REFERENCE TO RELATED APPLICATIONS

This patent application claims priority to provisional patent application No. 62/597,158 filed Dec. 11, 2017, and titled “MOTOR VEHICLE LIGHT COVER.” The subject matter of said is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNOLOGICAL FIELD

Most broadly, the disclosed subject matter relates to the field of accessories for motor vehicles, and more particularly, it is directed to light accessories for motor vehicles.

### BACKGROUND

Brake lights, rear lights, turn signal lights, tail lights, rear position lamps and tail lamps, are located at the rear of a motor vehicle. Conspicuity for the rear of a vehicle is provided by said lights. Rear lights are required to produce only red light and to be wired such that they are lit whenever the front light or head lights are lit and/or when the vehicle is turning. Rear lights may be combined with other lights, such as the vehicle's stop lights or separate from them. In combined-function installations, the rear lights may produce brighter red light for the stop light function or turning function. Regulations worldwide stipulate intensity ratios and blinking sequences between the different modes, so that a viewer, such as a vehicle located behind said lights, will not confuse their functions.

A rear light cover is a translucent or transparent cap or cover that is placed over a lightbulb, or a depression that holds the lightbulb for the rear light. The rear light cover serves a variety of purposes. A rear light cover may serve to protect the fragile lightbulb from debris and the elements, may serve to add color to the light of the lightbulb, as in the case of a red cover, and add aesthetics to the motor vehicle, as in the case of a stylized rear light cover.

A large variety of rear lights and rear light covers exist today, available in a large variety of colors, sizes and shapes. But rear lights and rear lights covers have not enjoyed many improvements over the last decades. For the most part, conventional rear lights and rear light covers that are commercially available today are almost identical to the rear lights and rear light covers that were available at the beginning of the 20^{th} century. Consequently, the conventional rear lights and rear light covers available today lack the innovation and ingenuity that attract consumers.

Consequently, a need exists to overcome the problems with the prior art as discussed above, and particularly for improved and innovative rear lights and rear light covers for consumers.

### SUMMARY

Briefly, according to an embodiment, cover for a motor vehicle light is disclosed. The cover includes a base having a cylindrical shape with a closed top end and an open bottom end, wherein at least the top end of the base is comprised of a material that allows light to pass through, a plurality of flanges extending perpendicularly from the bottom end of the base, wherein the plurality of flanges are configured to securely mate with slots located along a circumference of a motor vehicle light, a first surface on an exterior surface of the base, a cap having a cylindrical shape with an open bottom end and a closed top end, a plurality of bars extending across the top end of the cap, the plurality of bars comprised of a material that blocks light, a second surface on an interior surface of the cap configured to mate with the first surface of the base, wherein when the cap is welded onto the base, light from the motor vehicle light passes through the top end of the base and is blocked by the plurality of bars.

The foregoing and other features and advantages of the disclosed embodiments will be apparent from the following more particular description of the preferred embodiments, as illustrated in the accompanying drawings.

### BRIEF DESCRIPTION OF THE DRAWINGS

The claimed subject matter is particularly pointed out and distinctly claimed in the claims at the conclusion of the specification. The foregoing and other features and also the advantages of the disclosed embodiments will be apparent from the following detailed description taken in conjunction with the accompanying drawings.

FIG. 1 is a top view of the base for a motor vehicle light cover according to one embodiment;

FIG. 2 is a bottom view of the base for a motor vehicle light cover according to one embodiment;

FIG. 3 is a side view of the base for a motor vehicle light cover according to one embodiment;

FIG. 4 is a side view of the base for a motor vehicle light cover according to one embodiment;

FIG. 5 is a perspective view of the base for a motor vehicle light cover according to one embodiment;

FIG. 6 is a perspective view of the base for a motor vehicle light cover according to one embodiment;

FIG. 7 is a bottom perspective view of the base for a motor vehicle light cover according to one embodiment;

FIG. 8 is a top perspective view of the base for a motor vehicle light cover according to one embodiment;

FIG. 9 is a bottom perspective view of the base for a motor vehicle light cover according to one embodiment;

FIG. 10 is a perspective view of the base for a motor vehicle light cover according to one embodiment;

FIG. 11 is a perspective view of the base for a motor vehicle light cover according to one embodiment;

FIG. 12 is a top perspective view of the base for a motor vehicle light cover according to one embodiment;

FIG. 13 is a top view of the cap for a motor vehicle light cover according to one embodiment;

FIG. 14 is a bottom view of the cap for a motor vehicle light cover according to one embodiment;

FIG. 15 is a side view of the cap for a motor vehicle light cover according to one embodiment;

FIG. 16 is a side view of the cap for a motor vehicle light cover according to one embodiment;

FIG. 17 is a side view of the cap for a motor vehicle light cover according to one embodiment;

FIG. 18 is a side view of the cap for a motor vehicle light cover according to one embodiment;

FIG. 19 is a bottom perspective view of the cap for a motor vehicle light cover according to one embodiment;

FIG. 20 is a top perspective view of the cap for a motor vehicle light cover according to one embodiment;

FIG. 21 is a bottom perspective view of the cap for a motor vehicle light cover according to one embodiment;

FIG. 22 is a top perspective view of the cap for a motor vehicle light cover according to one embodiment;

FIG. 23 is a bottom perspective view of the cap for a motor vehicle light cover according to one embodiment;

FIG. 24 is a top perspective view of the cap for a motor vehicle light cover according to one embodiment;

FIG. 25 is a top view of a motor vehicle light cover in an assembled configuration according to one embodiment;

FIG. 26 is a bottom view of a motor vehicle light cover in an assembled configuration according to one embodiment;

FIG. 27 is a side view of a motor vehicle light cover in an assembled configuration according to one embodiment;

FIG. 28 is a side view of a motor vehicle light cover in an assembled configuration according to one embodiment;

FIG. 29 is a side view of a motor vehicle light cover in an assembled configuration according to one embodiment;

FIG. 30 is a side view of a motor vehicle light cover in an assembled configuration according to one embodiment;

FIG. 31 is a bottom perspective view of a motor vehicle light cover in an assembled configuration according to one embodiment;

FIG. 32 is a top perspective view of a motor vehicle light cover in an assembled configuration according to one embodiment;

FIG. 33 is a top perspective view of a motor vehicle light cover in an assembled configuration according to one embodiment;

FIG. 34 is a bottom perspective view of a motor vehicle light cover in an assembled configuration according to one embodiment;

FIG. 35 is a perspective view of a motor vehicle light cover in an assembled configuration according to one embodiment; and

FIG. 36 is a perspective view of a motor vehicle light cover in an assembled configuration according to one embodiment.

Like reference numerals refer to like parts throughout the several views of the drawings.

### DETAILED DESCRIPTION

The following detailed description is merely exemplary in nature and is not intended to limit the described embodiments or the application and uses of the described embodiments. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The disclosed embodiments solve the problems with the prior art by providing an innovative and ingenious cover for a motor vehicle light. The claimed subject matter further discloses a cover that includes a base that covers a motor vehicle light and may provide color or tint through which the light travels, as well as a cap that includes a plurality of bars that provide a louver-like or cage-like appearance to the light cover. The base allows the light to be colored, such as a red color that is used for brake lights, and the cap blocks light in bar like sequences, so as to provide a louver-like or cage-like look to the motor vehicle light. The claimed subject matter further protects the fragile lightbulb of the motor vehicle light from debris and the elements. The claimed subject matter further provides a unique and aesthetically attractive appearance to the motor vehicle light, which appeals to consumers.

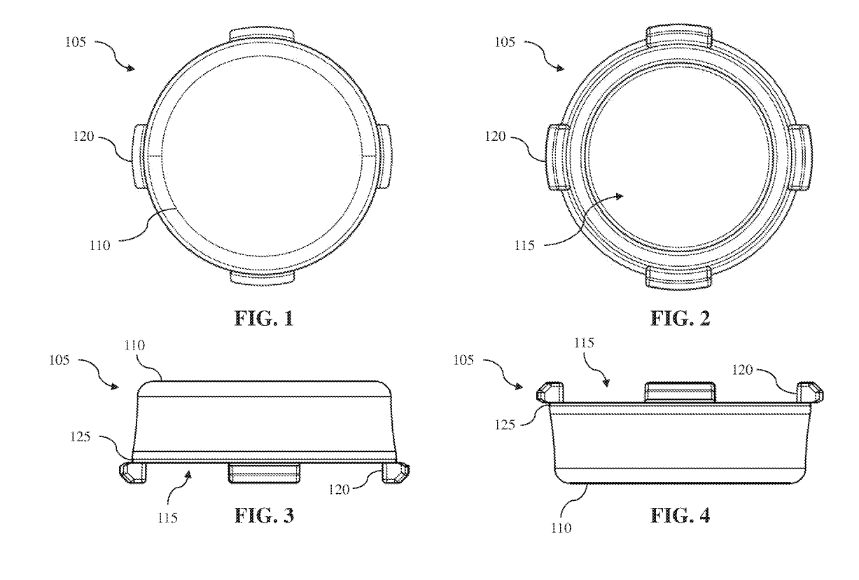

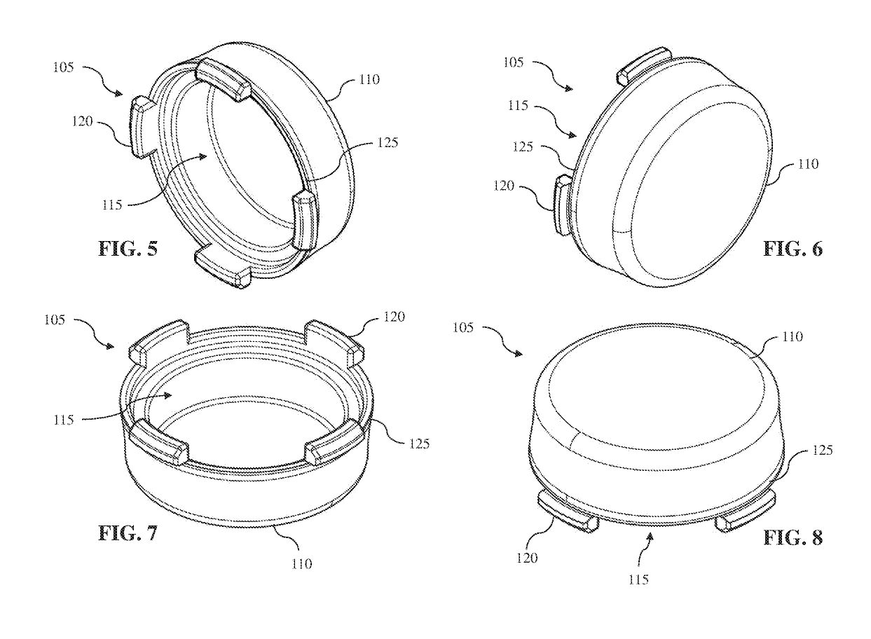

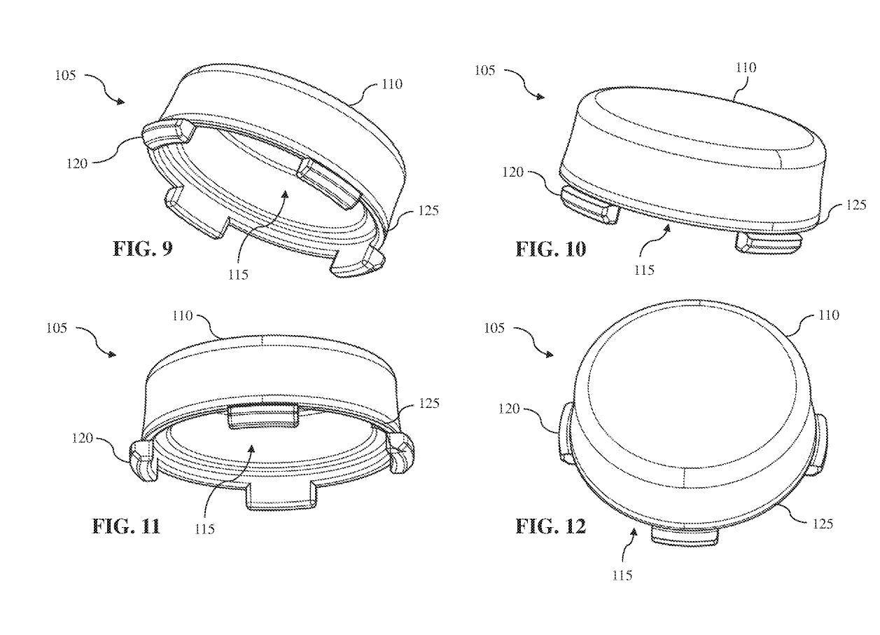

Referring now to the figures, FIGS. 1-12 illustrate top, bottom, side, and perspective views of the base for a motor vehicle light cover 100 according to one embodiment. The base 105 has a substantially cylindrical shape comprising a closed top end 110 and an open bottom end 115, wherein at least the top end of the base is comprised of a material that allows light to pass through. As will be discussed in greater detail below, the base is sized and shaped according to the cap such that the outermost diameter of the base can be snugly received by the inner diameter of the cap. It should be appreciated that the base can have other shapes and such variations are within the spirit and scope of the claimed invention. As can be seen in FIGS. 2 and 3, the base also includes a plurality of flanges 120 extending perpendicularly from the bottom end of the base. The plurality of flanges are substantially planar shaped and configured to securely mate with complementary slots located along a circumference of a motor vehicle light. As shown in FIG. 3, the base also includes a first surface 125 on an exterior surface of the base to receive a mating surface formed inside the cap, which will be discussed in greater detail below

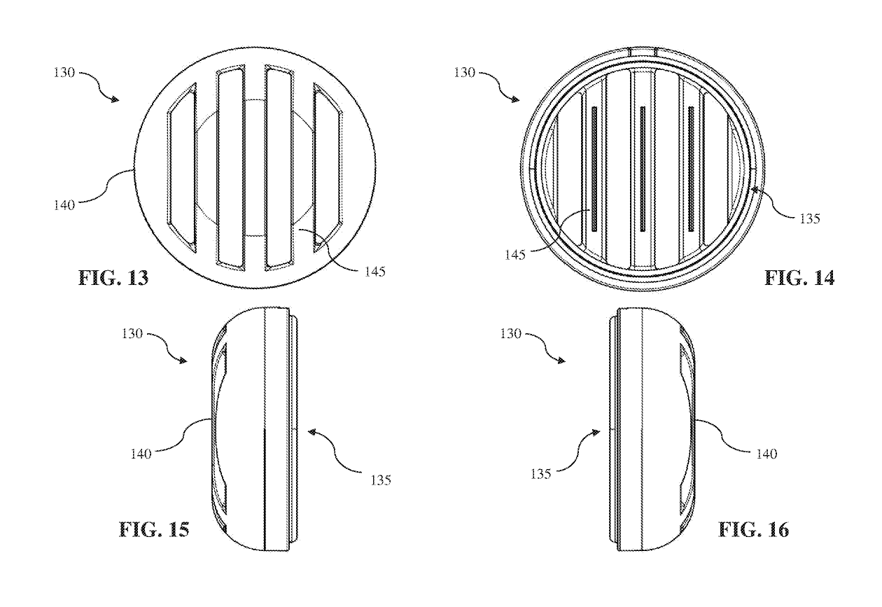

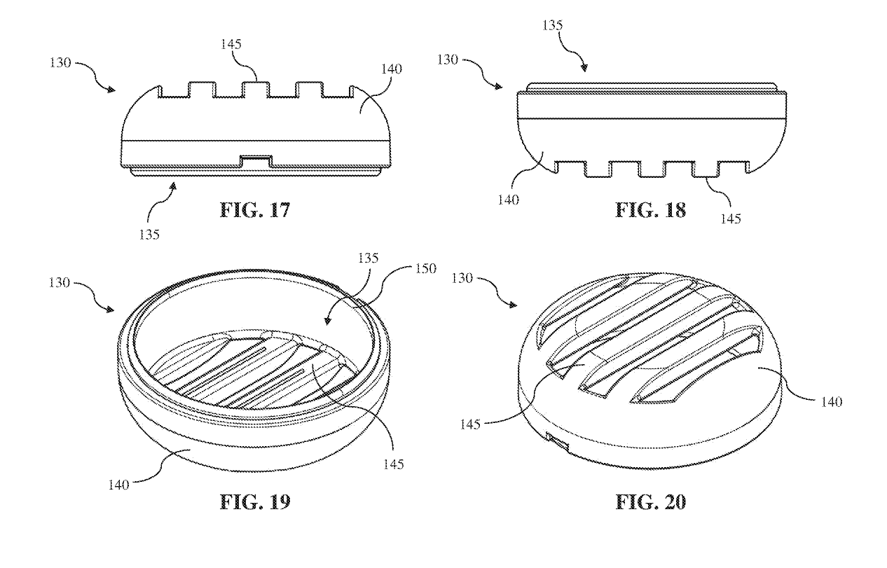

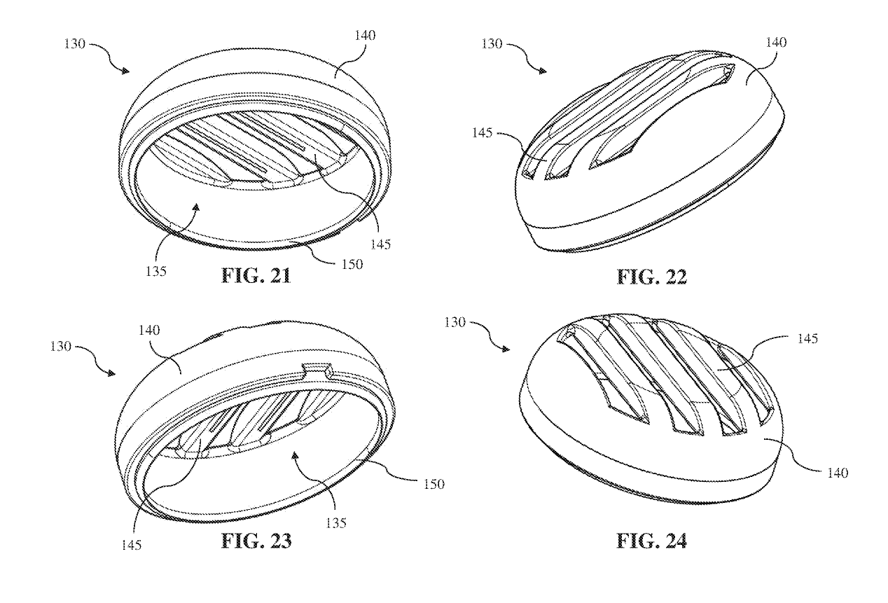

FIGS. 13-24 illustrate top, bottom, side, and perspective views of the cap for a motor vehicle light cover according to one embodiment. The cap 130 has a substantially cylindrical shape comprising an open bottom end 135 and a closed top end 140. The cap also includes a plurality of bars 145 extending across the top end of the cap. It should be appreciated that the cover opening can have other shapes and such variations are within the spirit and scope of the claimed invention. As shown in FIG. 13, the plurality of bars have a generally planar rectangular shape and are comprised of a material that blocks light to provide a louver-like or cage-like appearance to the light cover. The cap also includes a second surface 150 on an interior surface of the cap configured to mate with the first surface of the base, as shown in FIG. 19, wherein when the cap is welded onto the base, light from the motor vehicle light passes through the top end of the base and is blocked by the plurality of bars.

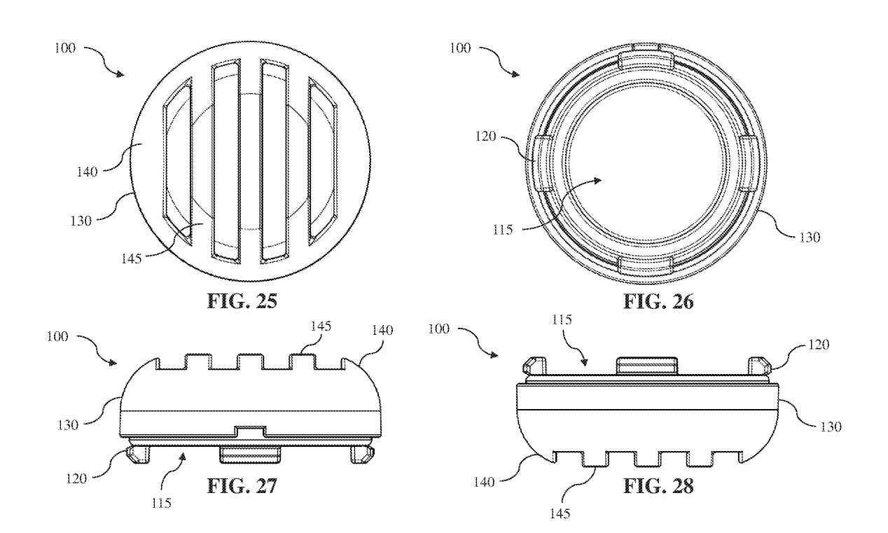

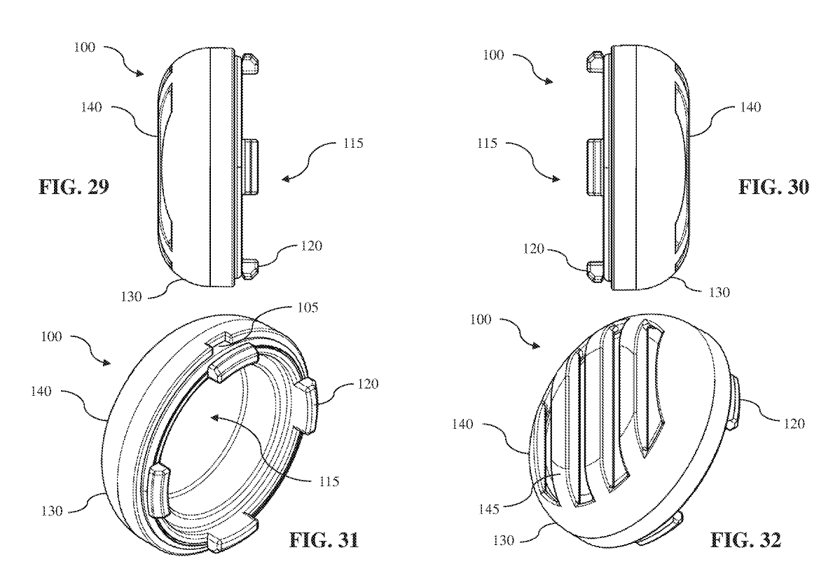

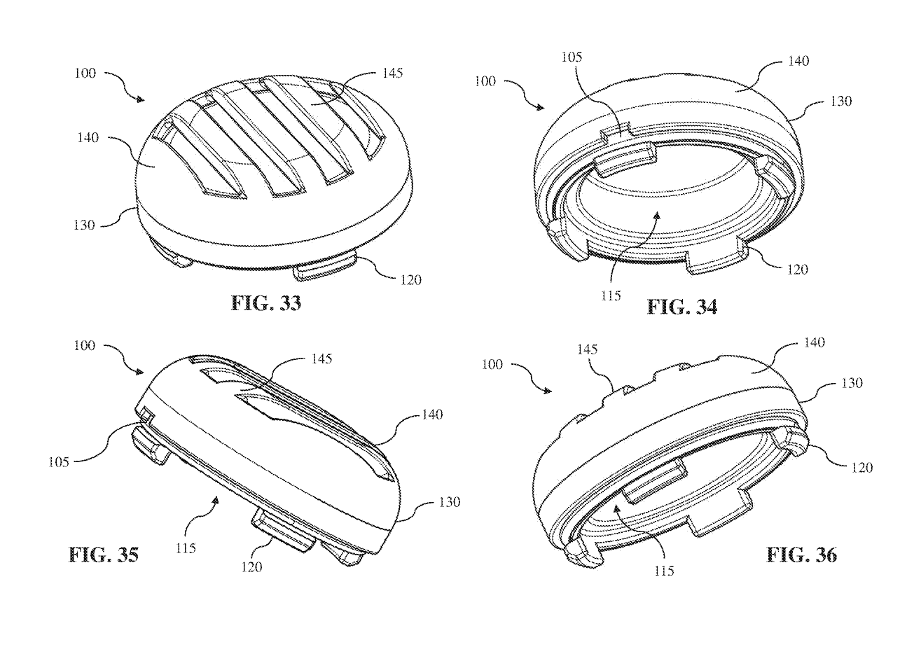

FIGS. 25-36 illustrate top, bottom, side, and perspective views of a motor vehicle light cover in an assembled configuration according to one embodiment. The motor vehicle light cover can be assembled by at least partially positioning the base into the interior portion of the cap such that the first surface 125 on the exterior surface of the base 105 can engage with the second surface 150 on the interior surface of the cap 130. It should also be appreciated that other attachment devices can be used to secure the base to the cap, such as screws, bolts, welds, pins, clamps, brackets, magnets, male-female interference-type connections, waterproof adhesives, or any other suitable method known in the art. Once the base and the cap are assembled together, the plurality of flanges pass into the interior space of a motor vehicle light to securely lock the cover in place.

In one embodiment, the base and cap and fastened together using ultrasonic welding. Ultrasonic welding is an industrial technique whereby high-frequency ultrasonic acoustic vibrations are locally applied to pieces being held together under pressure to create a solid-state weld. It is commonly used for plastics, and there are no connective bolts, nails, soldering materials, or adhesives necessary to bind the materials together. In one embodiment, the cap may include several (such as three) small conductors or legs located around a circumference of the second surface 150 of the cap, such that the conductors or legs melt during the ultrasonic welding process, so as to secure the two parts (base and cap) together.

In another embodiment, the motor vehicle light cover can be assembled by positioning the base into the interior portion of the cap such that the first surface 125 on the exterior surface of the base 105 can engage with the second surface 150 on the interior surface of the cap 130 to product a snap fit or a friction fit. A snap fit is an assembly method used to attach flexible parts, usually plastic, to form the final product by pushing the parts' interlocking components together. An interference fit, also known as a press fit or friction fit is a fastening between two parts which is achieved by friction after the parts are pushed together, rather than by any other means of fastening.

The base may be comprised of a translucent and colored material that may be colored red. The plurality of flanges may comprise four flanges spaced evenly around a circumference of the bottom end of the base. The plurality of bars may comprise three bars. The plurality of bars may be comprised of an opaque and colored material. The plurality of bars may be comprised of an opaque material colored black.

The base and cap may be manufactured from a variety of materials including metal, such as stainless steel, titanium, aluminum or any metal alloy, rigid fabric, carbon fiber, epoxy resin, graphite, rubber, plastic or any combination of the above.

Plastic covers a range of synthetic or semi-synthetic polymerization products. Plastics are composed of organic condensation or addition polymers and may contain other substances to improve performance or economics. In the claimed subject matter, plastic may comprise any one of the following forms of plastic: polyethylene, polystyrene, high impact polystyrene, polyethylene terephthalate, nylon, polypropylene, acrylonitrile butadiene styrene (ABS), bayblend and polyvinylidene chloride (PVC).

The base and cap may be manufactured from a plastic compound using any variety of processes, such as injection molding, fusible core injection molding and thermoforming. Injection molding is a manufacturing technique for making parts from thermoplastic material in production. The most commonly used thermoplastic materials are polystyrene, ABS or acrylonitrile butadiene styrene, nylon, polypropylene, polyethylene, and polyvinyl chloride or PVC. Fusible core injection molding or lost core injection molding is a specialized plastic injection molding process. Thermoforming is a manufacturing process for thermoplastic sheet or film.

In one embodiment, the base and cap may be manufactured from a material that is a solid color (or multiple solid colors), a transparent color (or multiple transparent colors) or may include a pattern or other series of multiple colors in a variety of selections. In another embodiment, the base and cap may include graphics, designs, logos, pictures, or any images that can be applied to the planar sheets. The graphics may be embedded in the material comprising the base and cap or the graphics may be stamped, painted, stenciled, laser etched, printed, engraved or silk-screened onto the exterior or interior surfaces of the planar sheets.

In one embodiment, the base and cap may be manufactured from a material that dissipates or insulates the heat created by the motor vehicle light during use. The material used to manufacture the base and cap, such as plastic, may possess heat isolative properties that prevent the outside surface of the device from overheating. Alternatively, the material used to manufacture the base and cover may possess any combination of heat insulating and heat conducting properties so as to accomplish the goal of re-directing the heat emanating from the light. Such redirection of the heat is beneficial as it reduces or eliminates the negative implications of high temperatures, including overheating or burning of a person's skin when contacting said cover.

Although specific embodiments have been disclosed, those having ordinary skill in the art will understand that changes can be made to the specific embodiments without departing from the spirit and scope of the claimed subject matter. The scope of the claimed subject matter is not to be restricted, therefore, to the specific embodiments. Furthermore, it is intended that the appended claims cover any and all such applications, modifications, and embodiments within the scope of the claimed subject matter.

We claim:

1. A cover for a motor vehicle light, comprising:
a base having a cylindrical shape with a closed top end and an open bottom end, wherein at least the top end of the base is comprised of a material that allows light to pass through;
a plurality of flanges extending perpendicularly from the bottom end of the base, wherein the plurality of flanges are configured to securely mate with slots located along a circumference of a motor vehicle light;
a first surface on an exterior surface of the base;
a cap having a cylindrical shape with an open bottom end and a closed top end;
a plurality of bars extending across the top end of the cap, the plurality of bars comprised of a material that blocks light;
a second surface on an interior surface of the cap configured to mate with the first surface of the base;
wherein when the cap is welded onto the base, light from the motor vehicle light passes through the top end of the base and is blocked by the plurality of bars.

2. The cover of claim 1, wherein the base is comprised of a translucent and colored material.

3. The cover of claim 2, wherein the base is comprised of a translucent material that is colored red.

4. The cover of claim 3, wherein the plurality of flanges comprises four flanges spaces evenly around a circumference of the bottom end of the base.

5. The cover of claim 4, wherein the plurality of bars comprises three bars.

6. The cover of claim 5, wherein the plurality of bars are comprised of an opaque and colored material.

7. The cover of claim 6, wherein the plurality of bars are comprised of an opaque material colored black.

8. A cover for a motor vehicle light, comprising:
a base having a cylindrical shape with a closed top end and an open bottom end, wherein at least the top end of the base is comprised of a material that allows light to pass through;
a plurality of flanges extending perpendicularly from the bottom end of the base, wherein the plurality of flanges are configured to securely mate with slots located along a circumference of a motor vehicle light;
a first surface on an exterior surface of the base;
a cap having a cylindrical shape with an open bottom end and a closed top end, wherein the open bottom end of the cap is configured to accept the closed top end of the base;
a plurality of bars extending across the top end of the cap, the plurality of bars comprised of a material that blocks light;
a second surface on an interior surface of the cap configured to mate with the first surface of the base;
wherein when the second surface on the interior of the cap is welded onto the first surface on the exterior surface of the base, light from the motor vehicle light passes through the top end of the base and is blocked by the plurality of bars.

9. The cover of claim 8, wherein the base is comprised of a translucent and colored material.

10. The cover of claim 9, wherein the base is comprised of a translucent material that is colored red.

11. The cover of claim 10, wherein the plurality of flanges comprises four flanges spaces evenly around a circumference of the bottom end of the base.

12. The cover of claim 11, wherein the plurality of bars comprises three bars.

13. The cover of claim 12, wherein the plurality of bars are comprised of an opaque and colored material.

14. The cover of claim 13, wherein the plurality of bars are comprised of an opaque material colored black.
